(19) United States
(12) Patent Application Publication
(10) Pub. No.: US 2011/0164506 A1
(43) Pub. Date: Jul. 7, 2011

(54) Inferring Packet Management Rules

(76) Inventors: Angelos Stavrou, Springfield, VA (US); Sushil Jajodia, Oakton, VA (US); Charalampos Andrianakis, Fairfax, VA (US)

(21) Appl. No.: 12/835,228

(22) Filed: Jul. 13, 2010

Related U.S. Application Data
(60) Provisional application No. 61/289,126, filed on Dec. 22, 2009.

(51) Int. Cl. H04L 12/56

(52) U.S. Cl. 370/241

(57) ABSTRACT

Embodiments of the present invention include a system or method for inferring packet management rules of a packet management device. A probing device is used to extract at least one of port number and IP address from a packet management configuration file. The probing device classifies extracted numbers and selectively transmits packets to a packet management device. A packet analyzer notifies the probing device when a packet passes through the packet management device. Based on the notification, the probing device is able to transmit packets to the packet management device in a non-exhaustive manner and determine a port range corresponding to a packet management rule.

### CROSS-REFERENCE TO RELATED APPLICATIONS

This application claims the benefit of U.S. Provisional Application No. 61/289,126, filed Dec. 22, 2009, entitled “Tool for Inferring Firewall Policy”, which is hereby incorporated by reference in its entirety.

### BRIEF DESCRIPTION OF THE SEVERAL VIEWS OF THE DRAWINGS

The accompanying drawings, which are incorporated in and form a part of the specification, illustrate embodiments of the present invention and, together with the description, serve to explain the principles of the invention.

FIG. 1 is a system diagram of a packet management rule inferring system as per an aspect of an embodiment of the present invention.

FIG. 2 is a system diagram of a packet management rule inferring system as per an aspect of an embodiment of the present invention.

FIG. 3 is a system diagram of a packet management rule inferring system as per an aspect of an embodiment of the present invention.

FIG. 4 is a block diagram of a probing device as per an aspect of an embodiment of the present invention.

FIG. 5 is a block diagram of a packet analyzer as per an aspect of an embodiment of the present invention.

FIG. 6 is a flow diagram of a packet management rule parser as per an aspect of an embodiment of the present invention.

FIG. 7 is a flow diagram of a port classification process of the packet management rule parser as per an aspect of an embodiment of the present invention.

FIG. 8 is a flow diagram of a port range determination process of the packet management rule parser as per an aspect of an embodiment of the present invention.

FIG. 9 is a flow diagram of a port range determination process for a minimum port of range port number as per an aspect of an embodiment of the present invention.

FIG. 10 is a flow diagram of a port range determination process for a maximum port of range port number as per an aspect of an embodiment of the present invention.

FIG. 11 is a flow diagram of a port range determination process for a middle port of range port number as per an aspect of an embodiment of the present invention.

### DETAILED DESCRIPTION OF EMBODIMENTS

Embodiments of the present invention infer packet management rules of a packet management device. Packet management devices provide security for a computer network by enforcing a policy for received packets. A packet management policy may contain individual rules that specify whether a certain packet is accepted, blocked, or modified. Understanding and maintaining a properly configured policy is crucial to the safety of the computer network. However, the rules of a packet management device are not easily obtainable. Packet management configuration files contain a list of rules for a packet management device, but come in numerous unique formats. It is undesirable to require an administrator to use multiple configuration file formats where devices from different vendors are commonly deployed.

Whenever a new device is deployed, network administrators may need to configure the new device and make sure that the new device enforces the global policy. Configuring packet management devices may be a difficult task especially when there are many different vendors and products, each using individual configuration tools. While active probing techniques may be used to discover packet management rules, the process may be time consuming. Active probing requires generating and transmitting packets to the packet management device, and inferring packet management rules according to the received responses. This process may be time consuming because an exhaustive or brute force search requires transmitting packets to each IP address and/or port number to determine what action a packet management device performs for each packet. An exhaustive search on IPv4 for the TCP protocol would require transmitting approximately 2³²*2¹⁶ packets. In IPv6, the number of packets required becomes so great that it may be infeasible to do an exhaustive search by using active probing techniques.

Packet management rules may also be parsed from a packet management configuration file and exported into a high level format that is easier to understand. However, the specific formatting a vendor used in creating a configuration file must be known in order to recognize the packet management rules. Vendors can use multiple independent formats for their configuration files, and the configuration file formatting may later change when updated by the vendor.

Embodiments of the present invention may infer packet management rules without transmitting packets to a packet management device in an exhaustive manner and without knowledge of the vendor formatting of the configuration file. IP addresses and port numbers may be extracting from a packet management configuration file by analyzing simple patterns within the configuration file. After obtaining IP addresses and port numbers, the packet management device may be probed by generating packets that belong to the extracted IP and port number ranges.

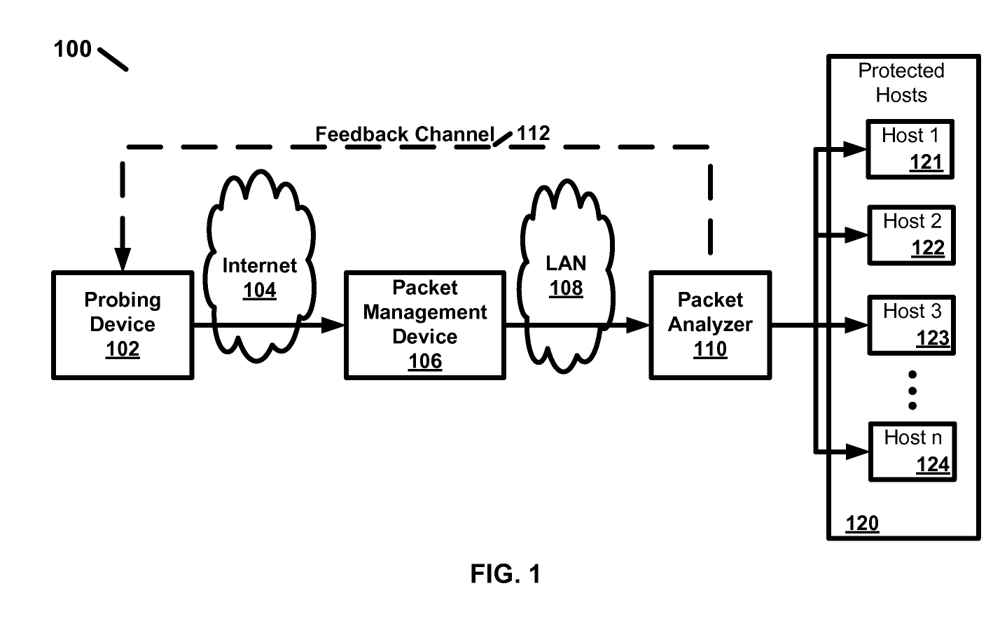

FIG. 1 illustrates packet management rule inferring system 100 including probing device 102, packet management device 106, packet analyzer 110, and protected host(s) 120. Probing device 102 and packet management device 106 are connected via Internet 104. Probing device 102 is configured to transmit packets designating any of protected host(s) 120 which may be received by packet management device 106. The transmitted packets may be used to help determine rules related to the incoming packet management policy of packet management device 106.

Packet management device 106 enforces a packet management policy for packets received from Internet 104 or local area network (LAN) 108. The packet management policy may be a firewall controlling access to and from protected host(s) 120. The policy may also be a network address translation (NAT) in which the IP addresses of certain packets are modified. Packet management device 106 may be a device such as a server or router that manages the traffic of received packets.

Packet analyzer 110 and packet management device 106 may be configured to be connected via LAN 108. Packet analyzer 110 receives packets transmitted by probing device 102 and routed through packet management device 106. Packet analyzer 110 may determine whether a packet sent to any of protected host(s) 120 is forwarded or has been dropped by packet management device 106. The feedback channel 112 may be used by packet analyzer 110 to notify probing device 102 when a packet is forwarded by packet management device 106. Feedback channel 112 can be either a direct or indirect connection between packet analyzer 110 and probing device 102. Feedback channel 112 is shown as routing information external to packet management device 106, but may also function by routing information through packet management device 106.

As shown in the present example, protected host(s) 120 include host 1, host 2, host 3, and host n labeled as 120, 122, 123, and 124. The protected host(s) 120 are connected to the Internet through the packet management policy of packet management device 106, but may be connected to the Internet from other sources. The protected host(s) 120 may contain any number of individual computers.

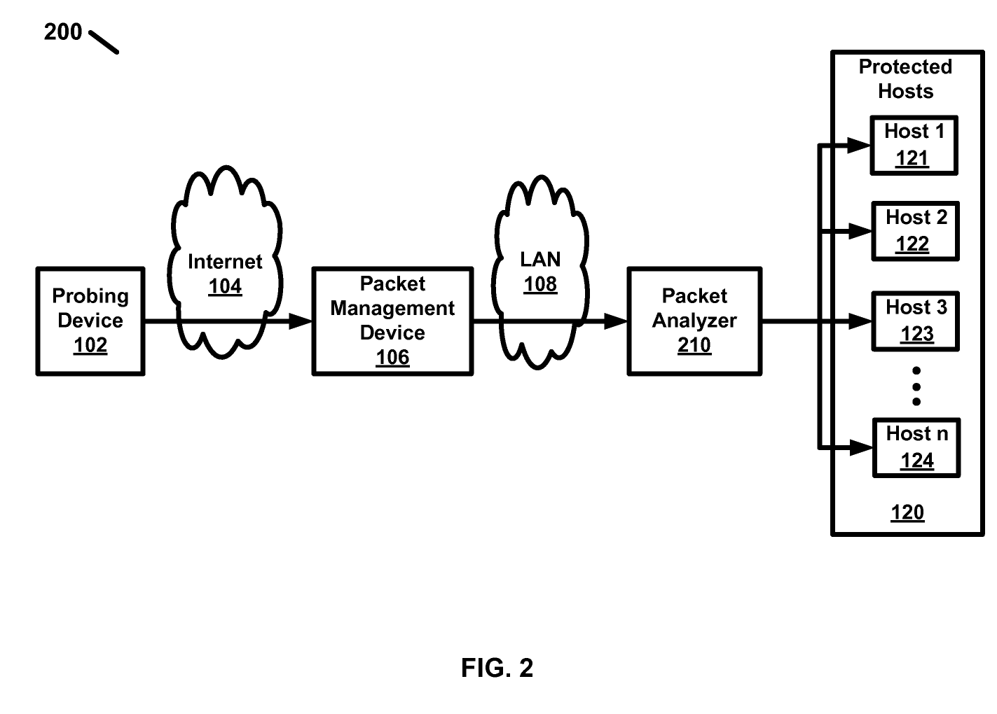

FIG. 2 shows another embodiment with packet management rule inferring system 200 including probing device 102, packet management device 106, packet analyzer 210, and protected host(s) 120. Packet management rule inferring system 200 operates similar to packet management rule inferring system 100 except that packet analyzer 210 is provided without a feedback channel to probing device 102. Like packet analyzer 110, packet analyzer 210 determines whether a packet sent to any of protected host(s) 120 is forwarded or has been dropped by packet management device 106. Instead of actively notifying probing device 102 whenever a packet is forwarded, packet analyzer 210 may maintain a list of packets that are routed through packet management device 106. The list of routed packets may include the source IP address, source port number, destination IP address, and destination port number. At some point packet analyzer 210 may transfer the list of routed packets to probing device 102. Probing device 102 may analyze the list of routed packets to determine which further packets if any should be sent to packet management device 106 to determine the packet management rules.

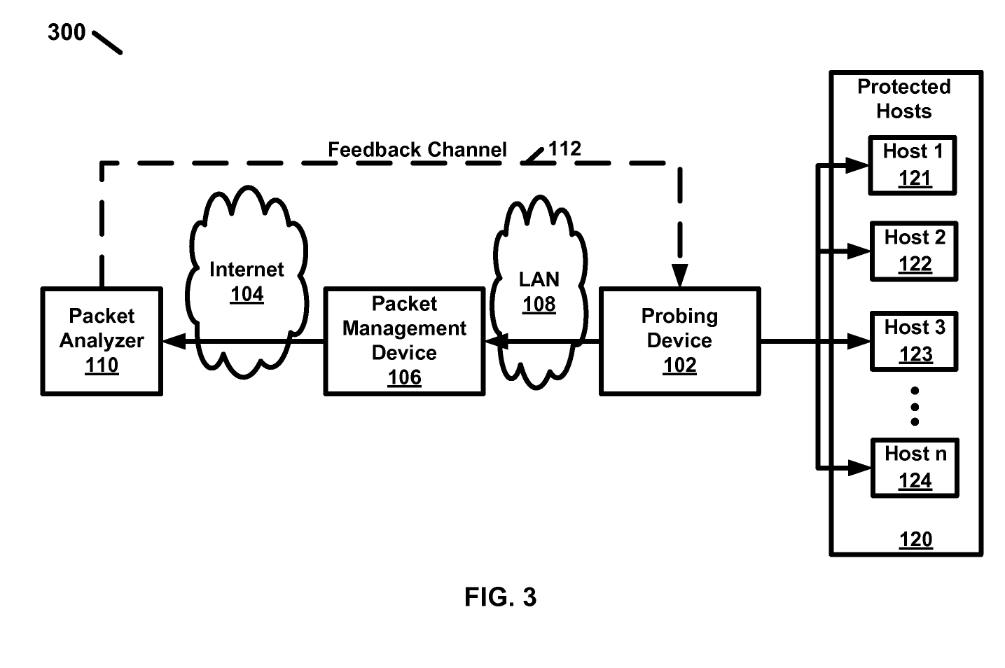

FIG. 3 illustrates another embodiment of the invention in which packet management rules are inferred that are related to an outgoing policy of packet management device 106. In FIG. 3, packet management rule inferring system 300 includes probing device 102, packet management device 106, packet analyzer 110, and protected host(s) 120. Packet management rule inferring system 300 is similar to packet management rule inferring system 100 except that the positions of probing device 102 and packet analyzer 110 are switched. Probing device 102 transmits packets through packet management device 106 within LAN 108. Packet analyzer 110 determines whether a packet is forwarded by the packet management device 106 through Internet 104. The feedback channel 112 may be used by packet analyzer 110 to notify probing device 102 when a packet is forwarded. Packet analyzer 110 may also compile a list of routed packets as described in reference to FIG. 2. Probing device 102 may use the information of which packets pass through packet management device 106 to determine the rules related to the outgoing packet management policy of packet management device 106.

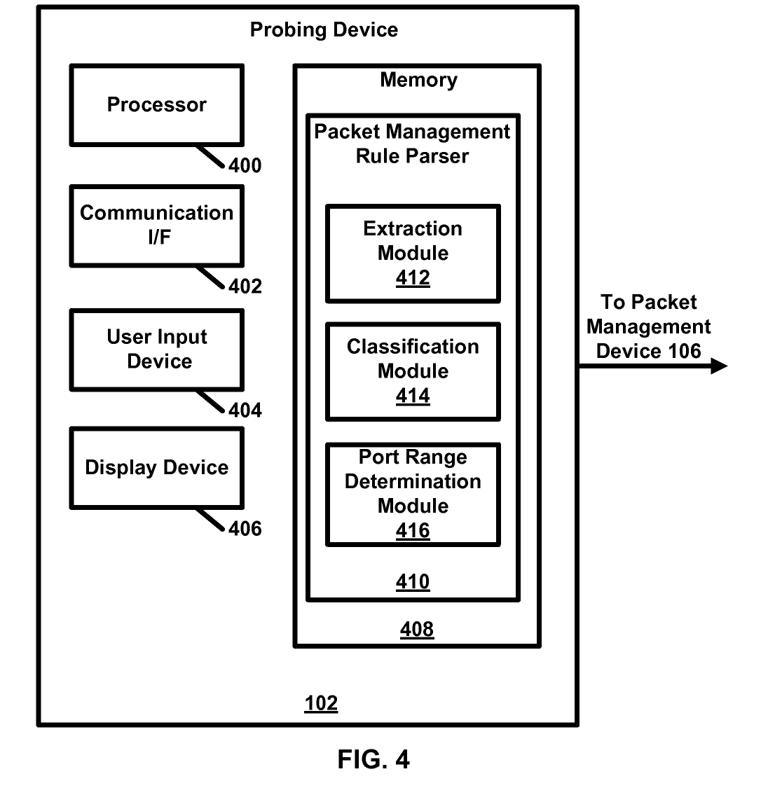

FIG. 4 shows a probing device 102 including processor 400, communication interface 402, user input device 404, display device 406, and memory 408. Probing device 102 may be part of a server storing packet management inferring software, or can be a specialized device for inferring packet management rules. Processor 400 can be a hardware device configured to execute software that can be stored in memory 408.

Memory 408 may include combinations of volatile memory elements and/or nonvolatile memory elements. Memory 408 may also incorporate electronic, magnetic, optical and/or other types of storage media. The memory 408 may include one or more separate programs, each of which comprises an ordered listing of executable instructions for implementing logical functions. The memory 408 may include packet management rule parser 410 and a suitable operating system. The packet management rule parser 410 may be configured to infer the rules of packet management device 106. Packet management rule parser 410 may include extraction module 412, classification module 414, and port range determination module 416.

The communication interface 402 allows data to be transferred between probing device 102 and external devices. Communication interface 402 may be a modem, a network interface, a communications port, a PCMCIA slot, or other communication device. Data transmitted or received by communication device 402 can include electronic, electromagnetic, optical, or other signals.

The user input device 404 may include one or more input devices such as a keyboard and/or mouse. User input device 404 may also be any device that is configured to communicate information from a user to the probing device 102. Display device 406 is a monitor for outputting visual information to a user. Probing device 102 may operate without user input device 404 and display device 406, and user input device 404 and/or display device 406 may be omitted.

When the packet management rule parser 410 is implemented in software, it should be noted that the packet management rule inferring system may be stored on any computer-readable medium for use by or in connection with any computer-related system or method. A computer-readable medium is an electronic, magnetic, optical, or other physical device or means that can contain or store data for a computer program for use by or in connection with a computer-related system or method. Packet management rule inferring system may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The computer-readable medium can include a random access memory, a read-only memory, an erasable programmable read-only memory, or a portable compact disc. One skilled in the art will recognize that packet management rule parser 410 may be implemented using hardware components such as a field-programmable gate array (FPGA) for design reasons such as increased speed or reduced cost.

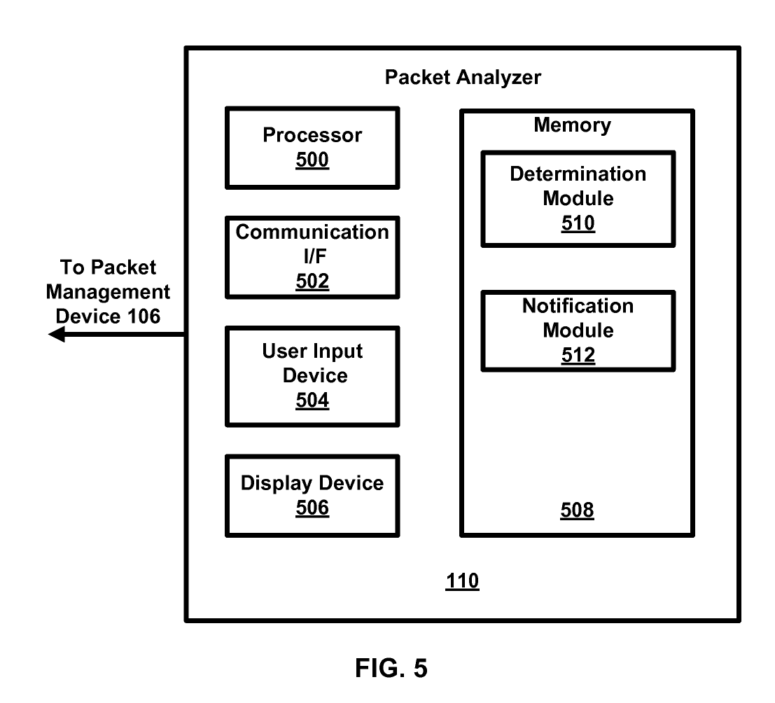

FIG. 5 is a drawing of packet analyzer 110 including processor 500, communication interface 502, user input device 504, display device 506, and memory 508. Packet analyzer 110 may be part of a server with packet detection software, or can be a specialized device designed to detect received packets. Processor 500 can be a hardware device configured to execute software that can be stored in memory 508.

Memory 508 may include any combination of volatile memory elements and/or nonvolatile memory elements. Memory 508 can also incorporate electronic, magnetic, optical and/or other types of storage media. The software in memory 508 may include one or more separate programs, each of which comprises an ordered listing of executable instructions for implementing logical functions. The software in memory 508 may include determination module 510, notification module 512 and a suitable operating system. Determination module 510 and notification module 512 may be embodied on a computer-readable medium such as a random access memory, a read-only memory, an erasable programmable read-only memory, or a portable compact disc.

The communication interface 502 allows data to be transferred between packet analyzer 110 and external devices. Communication interface 502 may be a modem, a network interface, a communications port, a PCMCIA slot, or other communication device. Data transmitted or received by communication device 502 can include electronic, electromagnetic, optical, or other signals.

The user input device 504 may include one or more input devices such as a keyboard and/or mouse. User input device 504 may also be any device that is configured to communicate information from a user to the packet analyzer 110. Display device 506 may be a monitor or other device such as a printer or speaker for conveying information to a user. Packet analyzer 110 may operate without user input device 504 and display device 506, and user input device 504 and/or display device 506 may be omitted.

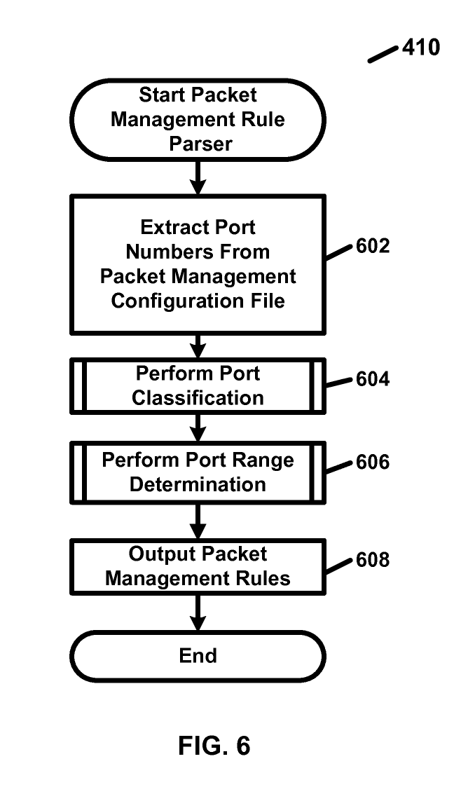

FIG. 6 is a flowchart of packet management rule parser 410 executed on probing device 102. Port numbers and IP addresses may be extracted from the packet management configuration file in 602 with extraction module 412. This may be accomplished by parsing the configuration file for any occurrence of whole numbers between 1 and 65535, and storing the results in a list of extracted port numbers. Other information may also be parsed from the configuration file including IP addresses. IP addresses are provided in configuration files in a dot-decimal notation. A list of extracted IP addresses may be compiled by parsing the occurrences of dot-decimal numbers in the configuration file.

The packet management configuration file consists of a set of packet management rules. Most vendors implement their own language for packet management rules. Although the grammar of each language may be substantially different for each configuration file, they mostly share some common characteristics. Configuration files generally include the same format when specifying source IP addresses, source port numbers, destination IP addresses, and destination port numbers. The packet management rule parser 410 obtains the common characteristics of the configuration file, and may not require any knowledge of specific format.

In 604, each port number extracted in 602 may be classified with classification module 414. The classification should help determine the packets that should be sent in order to efficiently extract the packet management rules. The port ranges may be determined for each packet management rule in 606 with port range determination module 416. Determining port ranges may be accomplished by transmitting packets to the packet management device 106 in a non-exhaustive manner. The port range determination 606 may determine port ranges of packet management rules without transmitting a packet to every port number, such as from 1 to 65535. The packet management rules are outputted in 608. This may occur through storing a file containing the rules on probing device 102, displaying the rules on a computer display, or printing out a hardcopy of the rules.

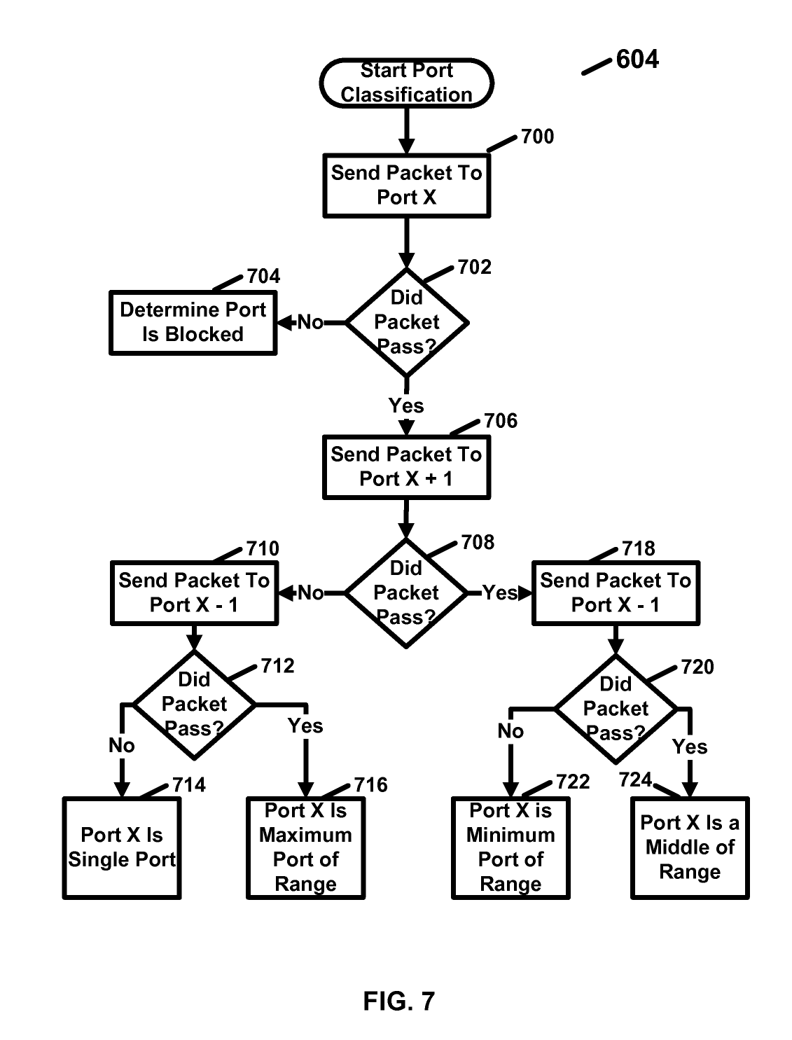

The port classification 604 is described in FIG. 7. Port number(s) extracted in 602 is classified as either a minimum port of a range, a middle of a port range, a maximum port of a range, or a single port. In 700 a packet is transmitted to packet management device 106 using the extracted number. The probing device 102 determines in 702 whether the packet passes through the packet management device 106. If the packet does not pass, the port number may be determined to be blocked in 704 and the port number is removed from the list of extracted port numbers. If the packet did pass through packet management device 106, a packet is sent to the port number directly following the extracted port number in 706. In 708 a determination may be made as to whether the packet transmitted to the port number directly following the extracted port number passed through the packet management device 106. Regardless of the result, a packet may also be sent to the port number directly preceding the extracted port number in 710 and 718.

If it is determined in 712 that the packet sent in 710 is blocked, the extracted port may be classified as a single port in 714. If the packet sent in 710 passes through packet management device 106, the extracted port may be classified as a maximum port of range in 716. When the packet transmitted in 706 passes through the packet management device 106, a determination may be made as to whether a packet sent to the port number directly preceding the extracted port number is blocked in 720. The extracted port number may be classified as a minimum port of range in 722 if the packet sent in 718 is blocked. Otherwise, the port number may be classified as a middle of range in 724.

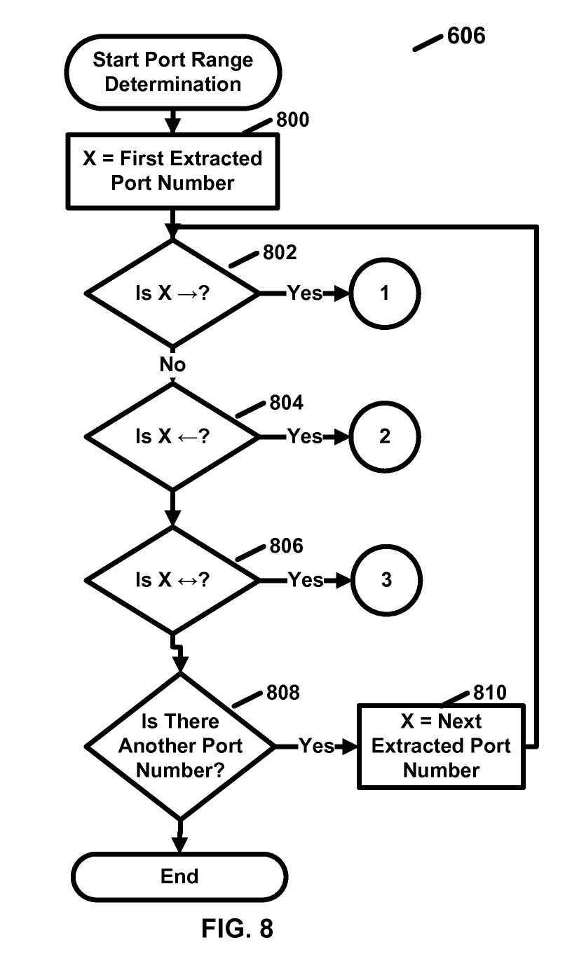

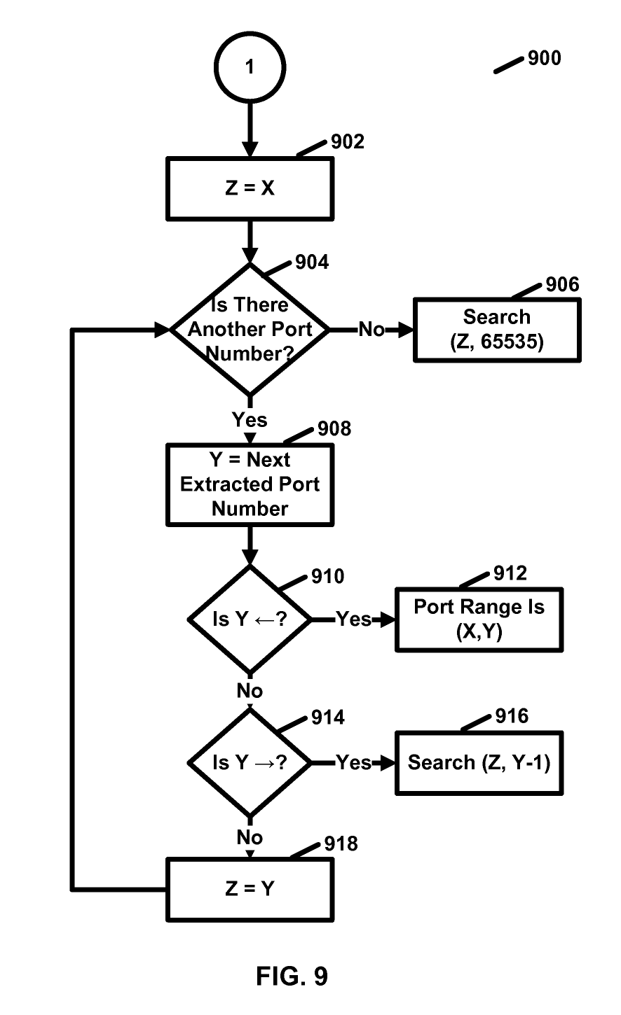

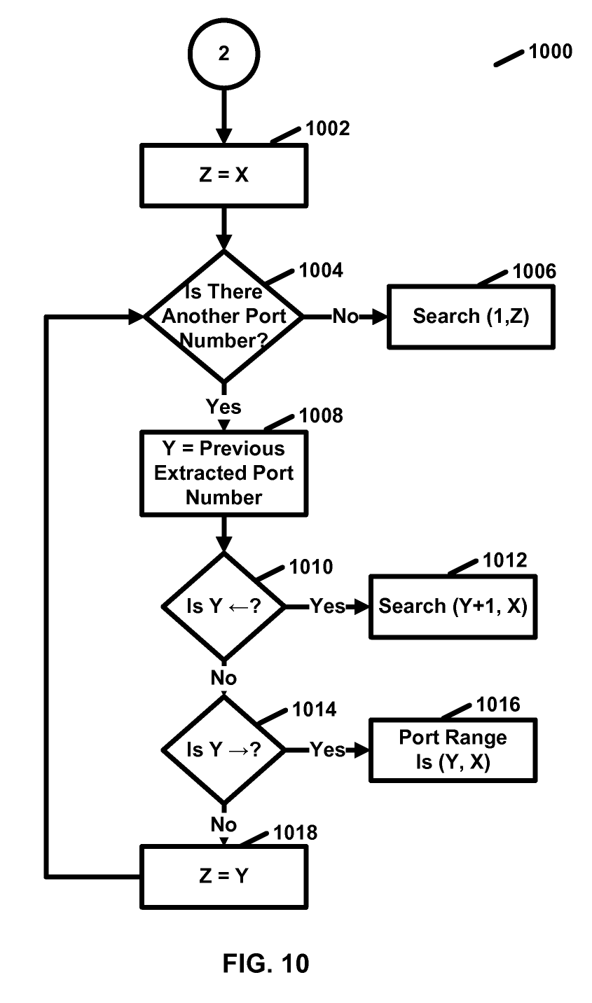

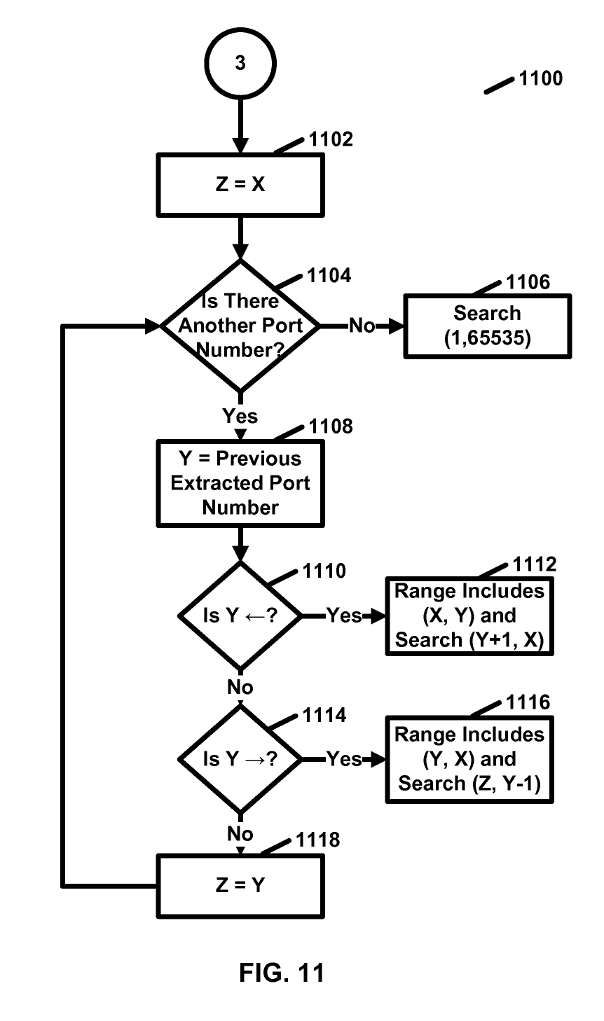

The port range determination 606 is explained in FIG. 8. In 800, the first port number from the list of extracted port numbers is analyzed. The program proceeds to the minimum port of range process 900 in FIG. 9 if it is determined in 802 that the extracted port number is classified as a minimum port of range. In 804, the program proceeds to the maximum port of range process 1000 in FIG. 10 if the extracted port number is classified as a maximum port of range. The program proceeds to the middle port of range process 1100 in FIG. 11 if it is determined in 806 that the extracted port number is classified as a middle port of range. In 808, it is determined whether there are further port numbers in the list of extracted port numbers to analyze. The port range determination 606 will continue and analyze the next extracted port number in 810 if there are further port numbers.

FIG. 9 illustrates a minimum port of range process 900. In 902, the extracted port number may be stored in a register Z. It is determined whether there is another port number in the list of extracted port numbers in 904. If the answer is negative, the probing device 102 in 906 may transmit packets using port numbers (Z, 65535) to determine a port range of a port management rule. Otherwise, the next port number from the list of extracted port numbers may be stored into register Y in 908. If Y is classified as a maximum port of range as determined by 910, the port range of a port management rule may be determined as (X,Y) in 912. In 914, a determination may be made as to whether Y is classified as a minimum port of range. When Y is a minimum port of range, the probing device 102 transmits packets using port numbers (Z, Y−1) to determine a port range of the port management rule in 916. When Y is not a minimum port of range, register Y may be stored into register Z in 918, and the process returns to 904.

FIG. 10 shows a maximum port of range process 1000. In 1002, the extracted port number may be stored in a register Z. A determination may be made as to whether there is another port number in the list of extracted port numbers in 1004. If the answer is negative, the probing device 102 in 1006 may transmit packets using port numbers (1, Z) to determine a port range of a port management rule. Otherwise, the next port number from the list of extracted port numbers may be stored into register Y in 1008. If Y is classified as a maximum port of range as determined by 1010, probing device 102 may transmit packets using port numbers (Y+1, X) to determine a port range of the port management rule in 1012. In 1014, a determination may be made as to whether Y is classified as a minimum port of range. When Y is a minimum port of range, the port range of a port management rule may be determined as (Y, X) in 1016. When Y is not a minimum port of range, register Y may be stored into register Z in 1018, and the process returned to 1004.

A middle port of range process 1100 is displayed in FIG. 11. In 1102, the extracted port number may be stored in a register Z. A determination may be made as to whether there is another port number in the list of extracted port numbers in 1104. If the answer is negative, the probing device 102 in 1106 may transmit packets using port numbers (1, 65535) to determine a port range of a port management rule. Otherwise, the next port number from the list of extracted port numbers may be stored into register Y in 1108. If Y is classified as a maximum port of range as determined by 1110, the port range of a port management rule may be determined as including (X,Y) in 1112. Additionally in 1112, the probing device 102 may transmit packets using port numbers (Y+1, X) to determine other port numbers that exist in the port range of the port management rule. In 1114, a determination may be made as to whether Y is classified as a minimum port of range. When Y is a minimum port of range, the port range of a port management rule may be determined as including (Y, X) in 1116. Additionally in 1116, the probing device 102 may transmit packets using port numbers (Z, Y−1) to determine other port numbers that exist in the port range of the port management rule. When Y is not a minimum port of range, register Y may be stored into register Z in 1118, and the process returns to 1104.

Embodiments of the present invention may also be used to determine a packet management policy independent of the packet management configuration file. Packet management configuration files may contain inefficient or contradicting rules. An accurate and condensed set of packet management rules can be obtained by probing the packet management device to detect an actual response.

Embodiments of the present inventions can also be applied to a network with multiple packet management devices. One or more probing devices can be used to transmit packets to a plurality of packet management devices by providing a packet analyzer for each packet management device.

It should be noted that references to “an” embodiment in this disclosure are not necessarily to the same embodiment, and they mean at least one. Flowcharts provided for the present invention may have alternative implementations of the functions noted in various steps or actions. The steps or actions may occur out of order, or may be executed substantially concurrently.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on packet management. However, one skilled in the art will recognize that embodiments of the invention could be applied to cellular communications, PTOS networks, Intranets, or other types of networks. Additionally, although some of the specific devices, such as the probing device packet analyzer or packet management device, are described as special purpose hardware devices, it is envisioned that such devices may be constructed from more general purpose hardware configured to function as operate as a specific device.

In addition, it should be understood that any figures which highlight the functionality and advantages, are presented for example purposes only. The disclosed architecture is sufficiently flexible and configurable, such that it may be utilized in ways other than that shown. For example, the steps or actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1) A system for inferring rules of a packet management device, comprising:
a) a probing device configured to operate on a first network connected to the packet management device, the probing device comprising:
i) an extraction module configured to extract at least one port number from a packet management configuration file;
ii) a transmission unit configured to transmit packets to the packet management device using:
(1) the at least one extracted port number;
(2) a second port number directly proceeding the extracted port number; and
(3) a third port number directly following the extracted port number;
iii) a reception unit configured to receive notification if the packets pass through the packet management device;
iv) a classification module configured to classify the at least one extracted port number as:
(1) a minimum port of a range;
(2) a middle of a port range;
(3) a maximum port of a range; or
(4) a single port;
v) a port range determination module configured to determine a range of port numbers for at least one packet management rule based on the classification of the at least one extracted port number by transmitting packets to the packet management device in a non-exhaustive manner;
vi) an output unit configured to output the at least one packet management rule based on the packet management configuration file, including at least one of:
(1) a set of source IP addresses;
(2) a set of source port numbers;
(3) a set of destination IP addresses;
(4) a set of destination port numbers; and
(5) a set of packet management actions; and
b) a packet analyzer configured to operate on a second network connected to the packet management device, the packet analyzer comprising:
i) a determination module configured to determine if the packets pass through the packet management device; and
ii) a notification module configured to send the notification to the probing device if the packets pass through the packet management device.

2) A non-transitory computer-readable storage medium comprising a program for causing a probing device to infer packet management rules, wherein the program comprises instructions for:
a) extracting at least one port number from a packet management configuration file;
b) transmitting packets from the probing device to a packet management device on a first network using the at least one extracted port number;
c) receiving a notification if the transmitted packet passes through the packet management device;
d) receiving, from a packet analyzer configured to be connected to the packet management device on a second network, a notification if the packets pass through the packet management device;
e) classifying the extracted port number based on the notification; and
f) determining a range of port numbers for at least one packet management rule based on the classification of the extracted port number by transmitting packets to the packet management device in a non-exhaustive manner

3) The non-transitory computer-readable storage medium of claim 2, wherein:
a) the packet management device comprises a server running a firewall; and
b) the packet management configuration file comprises a firewall configuration file.

4) The non-transitory computer-readable storage medium of claim 2, wherein:
a) the packet management device comprises a server configured to perform Network Address Translation; and
b) the packet management configuration file comprises a Network Address Translation configuration file.

5) The non-transitory computer-readable storage medium of claim 2, wherein classifying the extracted port number further comprises classifying the port number as:
a) a minimum port of a range;
b) a middle of a port range;
c) a maximum port of a range;
d) a single port; or
e) a combination of the above.

6) The non-transitory computer-readable storage medium of claim 2, wherein the program further comprises instructions for:
a) outputting at least one packet management rule for incoming packets to the packet management device based on the packet management configuration file; and
b) wherein the first network is a network external to a packet management device and the second network is a network internal to the packet management device.

7) The non-transitory computer-readable storage medium of claim 2, wherein the program further comprises instructions for:
a) outputting at least one packet management rule for outgoing packets from the packet management device based on the packet management configuration file; and
b) wherein the first network is a network internal to a packet management device and the second network is a network external to the packet management device.

8) The non-transitory computer-readable storage medium of claim 2, wherein the program further comprises instructions for:
a) determining, by the packet analyzer, if the packets pass through the packet management device; and
b) notifying the probing device on a feedback channel if the packets pass through the packet management device.

9) The non-transitory computer-readable storage medium of claim 2, wherein the program further comprises instructions for:
a) determining, by the packet analyzer, if the packets pass through the packet management device;
b) maintaining on the packet analyzer a list of port numbers of packets that pass through the packet management device; and
c) transmitting the list of port numbers to the probing device.

10) The non-transitory computer-readable storage medium of claim 2, wherein the program further comprises instructions for:
a) transmitting a second packet to a second port number directly proceeding the first port number;
b) transmitting a third packet to a third port number directly following the first port number; and
c) classifying the first port number based on whether the second packet and third packet passes through the packet management device.

11) The non-transitory computer-readable storage medium of claim 2, wherein the program further comprises instructions for outputting the packet management rules based on the packet management configuration file, including at least one of:
a) a set of source IP addresses;
b) a set of source port numbers;
c) a set of destination IP addresses;
d) a set of destination port numbers;
e) a set of packet management actions; or
f) a combination of the above.

12) The non-transitory computer-readable storage medium of claim 2, wherein the program further comprises instructions for outputting the packet management rules based on the packet management configuration file, the packet management configuration file including at least one of the following:
a) a set of source IP addresses;
b) a set of source port numbers;
c) a set of destination IP addresses;
d) a set of destination port numbers;
e) a set of packet management actions; or
f) a combination of the above.

13) The non-transitory computer-readable storage medium of claim 2, wherein each set includes two or more values.

14) The non-transitory computer-readable storage medium of claim 2, wherein the probing device is part of a server connected to the Internet.

15) The non-transitory computer-readable storage medium of claim 2, wherein the packet management configuration file comprises packet management rules for allowing or denying a received packet from passing through the packet management device.

16) A non-transitory computer-readable storage medium comprising a program for causing a packet analyzer to interact with a probing device to infer packet management rules, wherein the program comprises instructions for:
a) receiving from the probing device through a packet management device a first packet extracted from a packet management configuration file;
b) determining if the first packet passes through the packet management device;
c) notifying the probing device if the first packet passes through the packet management device;
d) receiving a second packet transmitted to a second port number directly proceeding the first port number;
e) receiving a third packet transmitted to a third port number directly following the first port number;
f) determining if the second and third packet passes through the packet management device;
g) notifying the probing device if the second and third packet passes through the packet management device, wherein the notification is used to classify the first port number; and
h) receiving additional packets transmitted in a non-exhaustive manner to determine a range of port numbers for at least one packet management rule.

17) The non-transitory computer-readable storage medium of claim 16, wherein:
a) the packet management device comprises a server running a firewall; and
b) the packet management configuration file comprises a firewall configuration file.

18) The non-transitory computer-readable storage medium of claim 16, wherein:
a) the packet management device comprises a server configured to perform Network Address Translation; and
b) the packet management configuration file comprises a Network Address Translation configuration file.

19) The non-transitory computer-readable storage medium of claim 16, wherein the packet analyzer notifies the probing device by using a feedback channel that is not routed through the packet management device.

20) The non-transitory computer-readable storage medium of claim 16, wherein the program further comprises instructions for:
a) maintaining on the packet analyzer a list of port numbers and IP addresses of packets that pass through the packet management device; and
b) packet analyzer notifies the probing device by transmitting the list of port numbers and IP addresses to the probing device.

21) The non-transitory computer-readable storage medium of claim 16, wherein the probing device is part of a server connected to the Internet.
